(19) United States
(12) Patent Application Publication
(10) Pub. No.: US 2016/0035450 A1
(43) Pub. Date: Feb. 4, 2016

(54) TALBOT INTERFEROMETER, TALBOT INTERFERENCE SYSTEM, AND FRINGE SCANNING METHOD

(71) Applicant: CANON KABUSHIKI KAISHA, Tokyo (JP)

(72) Inventors: Takashi Date, Kawasaki-shi (JP); Genta Sato, Kawasaki-shi (JP); Kimiaki Yamaguchi, Tokyo (JP)

(21) Appl. No.: 14/811,671

(22) Filed: Jul. 28, 2015

(30) Foreign Application Priority Data
Jul. 31, 2014 (JP) 2014-156730

(51) Int. Cl. G21K 1/06

(52) U.S. Cl. CPC G21K 1/067; G21K 2201/067

(57) ABSTRACT

In a Talbot interferometer including a diffractive grating which forms a first intensity distribution, a shield grating which forms a second intensity distribution, a detector which acquires information on the intensity distributions, and a moving unit which moves the first intensity distribution or the shield grating, fringe scanning in the x-axis and y-axis directions is performed in response to a change in relative positions of the first intensity distribution and the shield grating in the respective directions, and the detection before or after a change in the relative positions in the respective directions. The number of movements of the first intensity distribution or the shield grating with the fringe scanning in the directions is lower than Dx×(Dy+1)−2, where Dx and Dy are the numbers of detections with the fringe scanning in the respective directions and are integers equal to or higher than 3.

### BACKGROUND OF THE INVENTION

1. Field of the Invention

The present invention relates to a Talbot interferometer utilizing an X-ray, a Talbot interference system, and a fringe scanning method usable for the Talbot interferometer.

2. Description of the Related Art

An X-ray Talbot method utilizing Talbot interference is known as one of phase contrast imaging methods utilizing an X-ray phase difference caused by a subject. An X-ray Talbot method generally applies an X-ray Talbot interferometer including an X-ray source, a diffractive grating, a shield grating, and a detector. The diffractive grating is configured to diffract an X-ray and form an interference pattern (sometimes called a first intensity distribution) with a Talbot effect. The shield grating is placed at a position where the first intensity distribution is formed and shields a part of the X-ray forming the first intensity distribution to form a second intensity distribution. The detector is configured to detect the intensity of an X-ray through the shield grating to acquire information on the second intensity distribution.

X-ray Talbot-Lau interferometry is a kind of such an X-ray Talbot method. An X-ray Talbot-Lau interferometer which executes X-ray Talbot-Lau interferometry includes those components as described above and a source grating. The source grating is configured to divide an X-ray from an X-ray source into thin beams to generate a state that virtually minute X-ray sources are aligned for improved X-ray spatial coherence. The “X-ray Talbot method” simply called according to the present invention and herein includes X-ray Talbot-Lau interferometry, and the “X-ray Talbot interferometer” simply called according to the present invention and herein includes an X-ray Talbot-Lau interferometer.

When a subject is placed between the X-ray source (or virtual X-ray source or source grating in a Talbot-Lau interferometer) and the diffractive grating or between the diffractive grating and the shield grating, the subject modulates an X-ray, and the second intensity distribution changes in response to the modulation caused by the subject. The second intensity distribution changed by the subject is captured, and an arithmetic operation is performed as required on information of the second intensity distribution so that information on the subject may be acquired. A fringe scanning method is known as one method for imaging the second intensity distribution by using a Talbot interferometer. In a Talbot interferometer, changes in phase of the second intensity distribution and the second intensity distribution are repeatedly detected to execute the fringe scanning method. A change in phase of the second intensity distribution is caused by changing the relative positions of a self-image and shield grating by scanning the shield grating about the self-image, that is, by moving the self-image or shield grating.

PHYSICAL REVIEW LETTERS vol. 105, 248102 (2010). Two-Dimensional X-Ray Grating Interferometer. Irene Zanette/European Synchrotron Radiation Facility, Grenoble, France discloses a Talbot interferometer which executes a fringe scanning method utilizing a raster scanning as a two-dimensional fringe scanning method.

Because a fringe scanning method takes time for moving a self-image or shield grating involved in fringe scanning, the imaging time is also increased disadvantageously. The movement time is also influenced by not only the moving distance but also the number of movements.

### SUMMARY OF THE INVENTION

The present invention provides a Talbot interferometer including a diffractive grating configured to diffract an X-ray from an X-ray source to form a first intensity distribution in which a bright section and a dark section are aligned in two directions, a shield grating configured to shield a part of the X-ray forming the first intensity distribution to form a second intensity distribution in which a bright section and a dark section are aligned in an x-axis direction and a y-axis direction, a detector configured to detect an intensity of an X-ray from the shield grating to acquire information on the intensity distributions, and a moving unit configured to move the first intensity distribution or the shield grating. In this case, fringe scanning in the x-axis direction is performed in response to a change in relative positions of the first intensity distribution and the shield grating in the x-axis direction by the moving unit, and the detection before or after a change in the relative positions in the x-axis direction by the detector. Fringe scanning is performed in the y-axis direction in response to a change in relative positions of the first intensity distribution and the shield grating in the y-axis direction by the moving unit, and the detection before or after a change in the relative positions in the y-axis direction by the detector. The number of movements of the first intensity distribution or the shield grating by the moving unit involved in the fringe scanning in the x-axis direction and fringe scanning in the y-axis direction is lower than Dx×(Dy+1)−2, where Dx is the number of detections involved in the fringe scanning in the x-axis direction, Dy is the number of detections involved in the fringe scanning in the y-axis direction, and Dx and Dy are both integers equal to or higher than 3.

Further features of the present invention will become apparent from the following description of exemplary embodiments with reference to the attached drawings.

### BRIEF DESCRIPTION OF THE DRAWINGS

FIG. 1A is an explanatory diagram for a moving method according to a first embodiment.

FIG. 1B is an explanatory diagram for a moving method according to a second embodiment.

FIG. 2 is an overall configuration diagram of a Talbot interferometer according to the first and second embodiments.

FIGS. 3A to 3C are explanatory diagrams for the moving method according to the first embodiment.

FIG. 4 is an overall configuration diagram of a Talbot interferometer according to a third embodiment.

FIG. 5 is an explanatory diagram regarding an example of a rotary shutter according to the third embodiment.

FIG. 6 is an explanatory diagram regarding an example of the rotary shutter according to the third embodiment.

FIGS. 7A and 7B are explanatory diagrams regarding a moving method (raster scanning) in a technology in the past.

### DESCRIPTION OF THE EMBODIMENTS

Embodiments of the present invention will be described below with reference to attached drawings. Like numbers refer to like parts throughout the drawings, and repetitive description will be omitted. A Talbot interferometer according to any one of embodiments below is capable of executing a fringe scanning method in which at least one of the moving distance and the number of movements is less or lower than that of the fringe scanning method utilizing a raster scan method disclosed in PHYSICAL REVIEW LETTERS 105, 248102 (2010). Two-Dimensional X-Ray Grating Interferometer. Irene Zanette/European Synchrotron Radiation Facility, Grenoble, France.

In the past, a raster scan method has been utilized as disclosed in PHYSICAL REVIEW LETTERS 105, 248102 (2010). Two-Dimensional X-Ray Grating Interferometer. Irene Zanette/European Synchrotron Radiation Facility, Grenoble, France as a scanning method (referring to a method for moving the first intensity distribution or shield grating) in a fringe scanning method for a two-dimensional lattice. The raster scan method changes the relative positions of the first intensity distribution and the shield grating in a first direction and in a second direction intersecting the first direction between two successive detections (such as a Dxth detection and a (Dx+1)th detection) every time a plurality of (or Dx) detections are performed. In other words, the relative positions of the first intensity distribution and the shield grating are moved a total of twice, that is, once in the first direction and once in the second direction, between two successive detections. On the other hand, according to first and second embodiments, which will be described below, a scanning method is applied by which the number of movements to be performed between two successive detections may be equal to one. In other words, a scanning method according to the first and second embodiments performs the detection every movement of the relative positions of the shield grating and first intensity distribution in the first direction or every movement of the relative positions of the shield grating and first intensity distribution in the second direction to execute fringe scanning in the x-axis direction and the y-axis direction. Thus, the total number of movements may be lower than that of the raster scan method.

According to the raster scan method in the past, every time a plurality of (or (Dx−1)) movements are performed in the first direction, the shield grating or first intensity distribution is moved in the opposite direction of the first direction, and the relative positions in the first direction are returned to the positions before the Dxth detection. The scanning method according to the first and second embodiments, which will be described below, does not require the returning of the relative positions. Thus, the distance of movement of the first intensity distribution or shield grating required for performing fringe scanning in an x-axis direction and a y-axis direction may be reduced.

Embodiments will be described more specifically below.

### First Embodiment

According to this embodiment, a Talbot interferometer will be described which executes a fringe scanning method with a less movement time and a lower number of movements than those of the fringe scanning method utilizing a raster scan method. A Talbot interferometer according to this embodiment is a Talbot-Lau interferometer utilizing a Lau effect.

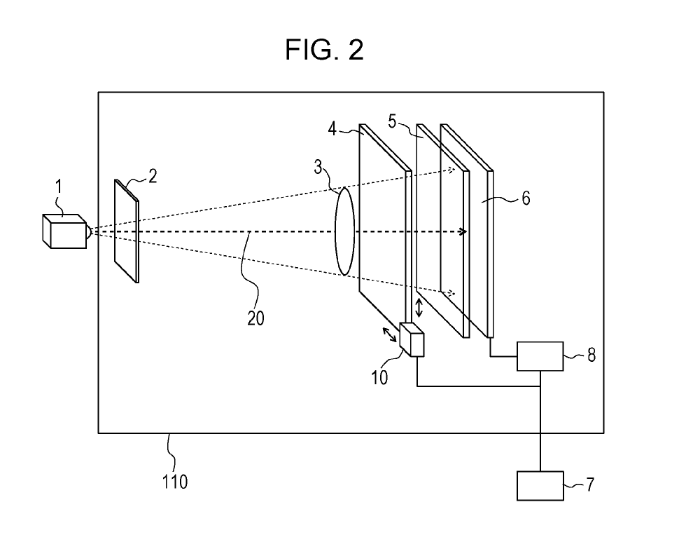

FIG. 2 illustrates an overall configuration of a Talbot interferometer according to this embodiment. A Talbot interferometer 110 according to this embodiment includes a source grating 2 configured to spatially divide an X-ray from the X-ray source 1, a diffractive grating configured to diffract the X-ray from the source grating to form a first intensity distribution, and a shield grating 5 configured to block a part of the X-ray forming the first intensity distribution. The Talbot interferometer 110 further includes a detector 6 configured to detect an X-ray from the shield grating, a moving unit 10 configured to move the diffractive grating on an xy plane perpendicular to an X-ray axis 20, and an instruction unit 8 configured to instruct the moving unit 10 and detector 6.

The Talbot interferometer 110 and an arithmetic unit 7 configured to perform an arithmetic operation on a detection result from the detector to acquire information on a subject are included in a Talbot interference system. Because the Talbot interferometer 110 according to this embodiment does not include an X-ray source, the Talbot interferometer 110 is capable of measuring (or capturing a second intensity distribution of) a subject in combination with the X-ray source 1. The Talbot interference system may include a display apparatus, not illustrated, configured to display information on a subject acquired by the arithmetic unit. The display apparatus may be a display or a printer, for example.

The components will be described below.

The X-ray source 1 may have a focal spot size generally used in laboratories and medical sites of several hundreds μm to several mm and applies a diverging X-ray (cone beam X-ray or fan beam X-ray). The term “X-ray” herein refers to electromagnetic waves having energy equal to or higher than 2 keV and equal to or lower than 100 keV. A wavelength select filter may be placed in an optical path of an X-ray emitted from the X-ray source.

The source grating 2 is a two-dimensional source grating having transmission units through which an X-ray transmits and a shield unit configured to shield an X-ray. The transmission unit and the shield unit are aligned in two directions. More specifically, the source grating 2 has a pattern in which a plurality of transmission units are periodically placed in two directions in the shield unit.

The source grating may have a plurality of transmission units each having a width in the order of several μm to several tens μm so that an X-ray emitted from the X-ray source may be divided into X-ray beams with several μm to several tens μm pitch for improved spatial coherence of the X-ray from the X-ray source. The use of the source grating allows use of an X-ray source having a larger focal spot size of several hundred μm appropriately. Though the shield unit does not have to completely shield an X-ray, the shield unit may have a higher shield factor for improved spatial coherence and may shield 80% of an X-ray or more incident vertically on the shield unit.

The diffractive grating of this embodiment is a phase grating 4 which is a phase type diffractive grating and diffracts an X-ray from the source grating 2 to form a first intensity distribution in which a bright section and a dark section are aligned in two directions. An amplitude type diffractive grating may be used as the diffractive grating, but a phase type diffractive grating may be more effective because of reduced loss of X-ray dose. The phase grating 4 of this embodiment is a two-dimensional phase grating in which a phase shift unit and a phase reference unit are aligned in two directions orthogonal to each other, and an X-ray passed through the phase shift unit has a phase shifted by a constant amount, compared with an X ray passed through the phase reference unit. Here, though a phase grating with an amount of shift of π or π/2 radian is generally used, a phase grating with other amounts of shift may be used. For example, a phase grating with an amount of shift of 2π/3 or 4π/3 may be used. A material used in the phase grating may be a substance, such as silicon, having a higher X-ray transmittance, for example. In accordance with the amount of phase shift, the period of the shift unit of the phase grating may sometimes be matched with the period in the first intensity distribution, or the ½ periods of the period of the phase shift unit may sometimes be matched with the period of the first intensity distribution.

The shield grating 5 is a two-dimensional shield grating in which transmission units each of which allows an X-ray to pass through and shield units each of which shields an X-ray are arranged periodically in two directions. The shield units may not shield an X-ray completely. However, because superposing a shield grating on the first intensity distribution to shield an X-ray sufficiently for forming a moire, 80% or more of an X-ray vertically incident on the shield units may be shielded.

The shield grating 5 is placed at a position where the first intensity distribution is formed (such that the distance to the diffractive grating may be a Talbot distance), and a part of the X-ray forming the first intensity distribution is shielded to form a second intensity distribution. The second intensity distribution is a two-dimensional intensity distribution in which a bright section and a dark section are placed in an x-axis direction and in a y-axis direction. The period (pitch) of the shield grating may have an equal value to or a slightly different value from that of the period of the first intensity distribution formed on the shield grating by the diffractive grating and may depend on the period of the second intensity distribution to be formed. For example, the period of the first intensity distribution formed on the shield grating may be different from the period of the shield grating or the direction of the first intensity distribution may be different from that of the shield grating to form a second intensity distribution (or moire) having a different period. Alternatively, the period of the first intensity distribution formed on the shield grating may be equal to the period of the shield grating and have an identical (parallel) distribution direction to form the second intensity distribution having an equal period to that of the first intensity distribution. The first intensity distribution and the shield grating having the same direction as the first intensity distribution allow formation of a second intensity distribution having the same direction as those directions. On the other hand, the first intensity distribution and the shield grating having directions different from each other allow formation of a second intensity distribution having a different direction from those distribution directions. In other words, the x-axis direction and y-axis direction may be different from or equal to the distribution direction of the first intensity distribution and may be different from or equal to the period direction of the shield grating. For simple description, it is assumed that the x-axis direction and the y-axis direction are parallel with the two array directions of the phase grating.

The detector 6 detects an intensity of an X-ray from the shield grating to acquire information on an intensity distribution thereof. The detector may only be required to be capable of detecting the intensity of an X-ray and acquiring information on an intensity distribution thereof and may be an indirect type X-ray detector including a scintillator and an image pickup element (such as a CCD). Alternatively, a direct type X-ray detector may be used which has a conversion layer configured to generate charges from an irradiated X-ray. Timing for performing the detection, exposure times and so on may be as instructed from the instruction unit 8.

The arithmetic unit 7 uses a detection result from the detector to calculate information on the subject 3 based on a change in the second intensity distribution. The information on a subject may include phase information, scatter information and absorption information on the subject, for example. The phase information is based on a phase change of an X-ray due to a subject and may be acquired by performing a phase recovery by using the change in the second intensity distribution. More specifically, the phase information, for example, may be information on a phase image or information on a differential phase image. The scatter information is based on scattering of an X-ray by a subject, and the absorption information is based on an X-ray absorption by a subject. Both of the scatter information and the absorption information may be acquired from a change in the second intensity distribution.

The arithmetic unit 7 uses a detection result acquired by the Talbot interferometer by performing fringe scanning in the x-axis direction to acquire information on a subject in the x-axis direction. The arithmetic unit 7 also uses a detection result acquired by the Talbot interferometer by performing fringe scanning in the y-axis direction to acquire information on the subject in the y-axis direction. The arithmetic unit 7 may be a computer having a processor, a memory, a storage device, and an input and output devices, for example. Alternatively, a part or all of functions may be replaced by hardware such as a logic circuit.

The arithmetic unit 7 and the instruction unit 8 may be implemented by one computer.

The moving unit 10 moves the phase grating 4 on an xy plane perpendicular to the X-ray axis 20 in accordance with an instruction from the instruction unit 8. The moving unit 10 is an actuator connected to a phase grating, for example. The actuator moves the phase grating in a first direction and a second direction both on the xy plane and intersecting each other. Thus, the intensity distribution changes, and the X-ray may be detected before and after the change of the intensity distribution so that fringe scanning may be performed. The first direction and the second direction may be parallel with the two period directions of the phase grating as much as possible so that the phase grating may be moved for one period by a shorter moving distance. However, when the phase grating is moved in the first direction, the relative positions of the first intensity distribution and the shield grating may move in the x-axis direction. Thus, the first direction may be different from (or may not be parallel with) the period direction of the phase grating. When the phase grating is moved in the second direction, the relative positions of the first intensity distribution and the shield grating may move in the y-axis direction. Thus, the second direction may be different from the period direction of the phase grating.

The value of distance for one movement of the phase grating in the first direction by the moving unit 10 may be a value with which a value acquired by multiplying the distance for one movement by the number of detections by fringe scanning is equal to a positive integral multiple of the period in the first direction of the phase grating. When the phase grating has a phase amount of shift of π/2, 2π/3, or 4π/3 and when the phase grating moves for one period, the first intensity distribution also moves by one period. When the phase grating has an amount of phase shift of π, the ½ periods of the phase grating is matched with one period of the first intensity distribution. Thus, in a case where a phase grating having a phase amount of shift of π is used, the value of distance for one movement of the phase grating on the first direction by the moving unit 10 may be a value with which a value acquired by multiplying the distance for one movement by the number of detections by fringe scanning is equal to a positive integral multiple of the ½ period in the first direction of the phase grating. For example, in a case where the period of the phase grating, such as a phase grating having a phase amount of shift of π/2, and the period of the first intensity distribution are matched, the first intensity distribution may be moved in the first direction to perform fringe scanning in the x-axis direction. In this case, the distance of one movement of the first intensity distribution is equal to Nx×mx+Nx/Dx where Dx is the number of detections, and Nx is the period of the first intensity distribution in the first direction. In this case, mx is an integer equal to or higher than 0, and Dx is an integer equal to or higher than 3. With mx=0 and Dx=3, the phase grating may be moved for ⅓ pitches in the first direction so that the first intensity distribution may be moved by Nx/3. The same is true in the y-axis direction. To perform fringe scanning in the y-axis direction, the distance of one movement of the first intensity distribution is equal to Ny×my+Ny/Dy where Dy is the number of detections, and Ny is the period of the first intensity distribution in the second direction. In this case, my is an integer equal to or higher than 0, and Dy is an integer equal to or higher than 3. For a shorter moving distance, mx and my are preferably small and are further preferable to be equal to 0 (that is, the moving distance in the first direction is equal to Nx/Dx, and the moving distance in the second direction is equal to Ny/Dy). The distance of one movement in the first or second direction refers to a moving distance in the first or second direction between two detections performed by a detector. In a case where the period of the phase grating, such as a phase grating having a phase amount of shift of it, and ½ of the period of the first intensity distribution are matched, Nx may be replaced by ½ Nx.

In a case where Dx detections are performed by fringe scanning in the x-axis direction and Dy detections are performed by fringe scanning in the y-axis direction, Dx x Dy detections allow the fringe scanning to be performed in the x-axis direction and y-axis direction. Instead of the movement of the phase grating, an X-ray source (or a virtual X-ray source formed by a source grating in a Talbot-Lau interferometer) may be moved to move the first intensity distribution. The amount of movement of the source grating for moving the first intensity distribution may be determined based on the fact moving the source grating by one period can move the first intensity distribution by one period. In a Talbot interferometer without such a source grating, an X-ray source fixing unit may be connected with a moving unit and may be moved to move an X-ray source.

Instead of moving the first intensity distribution, the shield grating may be moved to move the relative positions of the first intensity distribution and the shield grating. Also in a case where the shield grating is moved, the value of the distance of one movement of the shield grating in the first direction may be a value with which a value acquired by multiplying the distance for one movement by the number of detections by fringe scanning is equal to a positive integral multiple of the period in the first direction of the shield grating. For example, also in a case where the shield grating is used, for performing fringe scanning in the x-axis direction by moving the shield grating in the first direction, the aforementioned expression (Nx×mx+Nx/Dx) for the moving distance may be applied, where Nx is a period of the shield grating in the first direction.

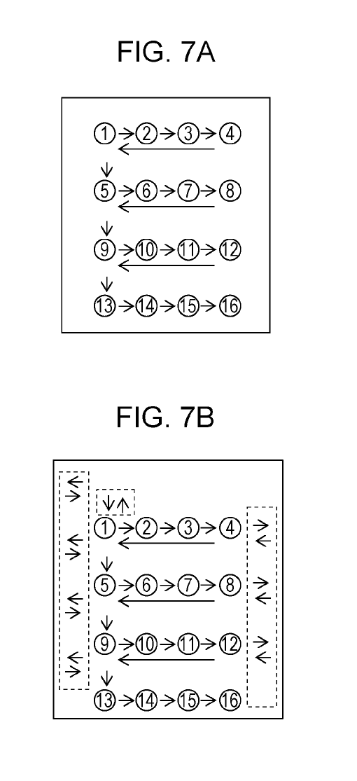

A method for moving such a phase grating by the raster scan method disclosed in PHYSICAL REVIEW LETTERS 105, 248102 (2010), Two-Dimensional X-Ray Grating Interferometer. Irene Zanette/European Synchrotron Radiation Facility, Grenoble, France will be described with reference to FIG. 7A. FIGS. 7A and 7B assume that the phase grating 4 is moved in the first direction (right direction) with the X-ray source, shield grating, detector, and subject fixed for performing fringe scanning in the x-axis direction, and the phase grating 4 is moved in the second direction (downward direction) for performing fringe scanning in the y-axis direction. A relationship of Dx=Dy=4 is also assumed. In FIGS. 7A and 7B, a detection is performed when a specific point (alignment point) of the diffractive grating is present at a number enclosed within a circle, and each arrow represents one movement. However, the number of movement in one direction among movements performed between detections is counted as one. In other words, because movements in the first and second directions occur between the fourth detection and the fifth detection in FIG. 7A, the number of movements performed between the detections is equal to two. Also, two movements are performed between the eighth and ninth detections and between the twelfth and thirteenth detections. In other words, according to the raster scan method, two movements are performed every Dx detections.

As illustrated in FIG. 7A, the number of movements required for performing two-dimensional fringe scanning with the x axis and the y axis is equal to 18. Assuming that one moving distance to the first direction (right direction in FIGS. 7A and 7B) is equal to 1, the moving distance in the opposite direction (left direction in FIGS. 7A and 7B) of the first direction is equal to 3, which is equivalent to an operation distance of 24. The moving distance in the opposite direction of the first direction is a moving distance required for return to the relative position. It may be formulated as (Dx+1)×Dy−2 where the number of movements Dy−1 in the opposite direction of the first direction is added to the number of movements Dx×Dy−1 in the first direction and second direction, from which the number of movements of the phase grating by a raster scan may be acquired. Because one moving distance in the first direction is equal to Nx/Dx, and one moving distance in the second direction is equal to Ny/Dy, the total moving distance is equal to Nx x (Dx−1)×(2Dy−1)÷Dx+Ny×(Dy−1)÷Dy. In a case where the shield grating is moved, Nx in the expression may be defined as a period of the shield grating in the first direction, and Ny may be defined as a period of the shield grating in the first direction.

In the Talbot interferometer according to this embodiment, the number of movements involved in fringe scanning in the x-axis direction and y-axis direction is lower than (Dx+1)×Dy−2. This is because the number of movements performed between the (n×Dx)th and (n×Dx+1)th detections may be equal to one, as described above. In this case, n is a positive integer. One movement is not required for each n, but one movement may be required for at least one n. In other words, when Dx=4, one movement may be performed between the fourth and fifth detections, and two movements may be performed between the eighth and ninth detections. However, one movement is preferably performed for each n. In this case, one movement is performed between all successive detections.

In addition, the Talbot interferometer of this embodiment allows a total moving distance involved in fringe scanning in the x-axis direction and y-axis direction to be lower than Nx×(Dx−1)×(2Dy−1)÷Dx+Ny×(Dy−1)÷Dy. It is allowed because of unnecessity of the return of the relative positions to be performed such that the relative positions in the x-axis direction upon the (n×Dx+1)th detection may be equal to those upon the ((n−1)×Dx+1)th detection, as described above. Like the number of movements, n is a positive integer, and the return of the relative positions is necessary for at least one n. However, the return of the relative positions may not be performed for all ns. In this case, the moving distance between all successive detections is equal to Nx×mx+Nx/Dx or Ny×my+Ny/Dy. Therefore, the imaging time including the time for moving the grating may be reduced, compared with a Talbot interferometer applying a fringe scanning method using raster scan.

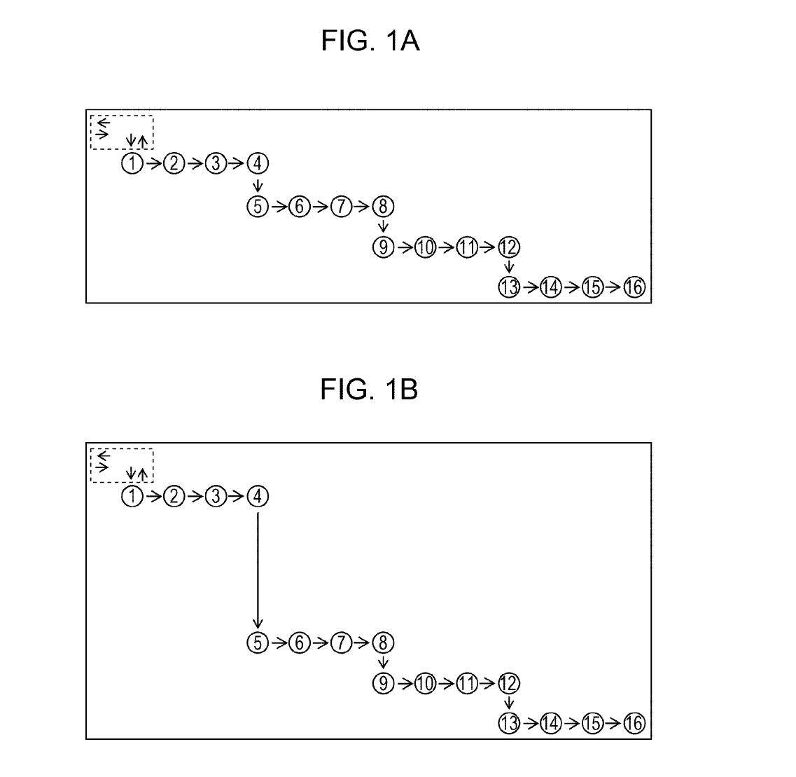

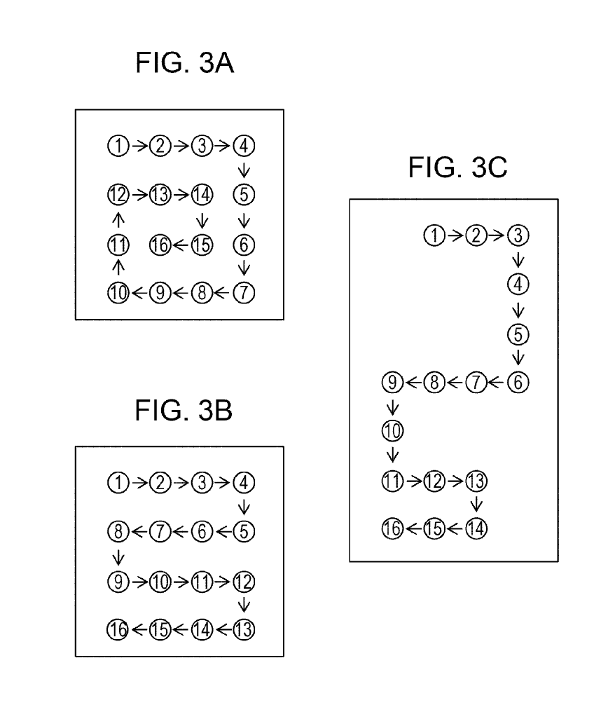

FIGS. 1A and 1B and 3A to 3C illustrate examples of methods for moving the phase grating in a fringe scanning method implemented by the Talbot interferometer according to this embodiment. The Talbot interferometer according to this embodiment may detect every one movement in the first or second direction (or the number of movement is equal to one for each n), as illustrated in FIGS. 1A and 1B and 3A to 3C. Here, when the first intensity distribution and the shield grating are at an identical relative position, a plurality of detections are not performed. That is, only one detection is performed for one relative position. Thus, fringe scanning in the x-axis direction and y-axis direction may be implemented by performing Dx×Dy−1 movements and Dx×Dy detections. The moving distance of one movement is as described above, and mx and my may be set such that the total moving distance may be lower than Nx×(Dx−1)×(2Dy−1)÷Dx+Ny×(Dy−1)÷Dy, and mx=my=0 is preferable.

FIG. 3A illustrates a scanning method in which the phase grating moves spirally from the outside to the center. Instead of the movements from 1 to 16, the phase grating may move from 16 to 1. In this case, the number of movements in one direction monotonously increases (for movements from 16 to 1) or monotonously decreases (for movements from 1 to 16). The term “monotonously increase” refers to f(x)≦f(y) where x<y while the term “monotonously decrease” refers to f(x)≧f(y) where x<y. Referring to FIG. 3A, for movements from 1 to 16, the phase grating moves three times in the right direction, three times in the downward direction, three times in the left direction, twice in the upward direction, twice in the right direction, once in the downward direction and once in the left direction. The number of movements in one direction monotonously decreases as 3, 3, 3, 2, 2, 1, 1.

FIG. 3B illustrates a scan method which repeats movements including Dx−1 movements in the first direction and then once in the second direction and Dx−1 movements in the opposite direction of the first direction and then once in the second direction.

The scanning methods illustrated in FIGS. 3A and 3B allow the phase grating to move in a narrower movement range. Therefore, in a case where an actuator having a narrow operation range is used as a moving unit, such as a piezoelectric actuator, the scanning method illustrated in FIG. 3A or 3B may be performed. However, if a constraint regarding an operation range is not significant, the scanning method as illustrated in FIG. 3C or FIG. 1 may be used instead. According to these scanning methods, one movement is performed between two successive detections, and one moving distance is equal to Nx×mx+Nx/Dx or Ny×my+Ny/Dy.

According to the scanning methods illustrated in FIGS. 1A and 1B and 3A to 3C, without limiting to the one illustrated in FIG. 3A, movements from 16 to 1 may be performed, instead of movements from 1 to 16. In addition, the illustrated downward direction may be handled as the first direction, and the right direction may be handled as the second direction. Having described the case with Dx=Dy with reference to FIGS. 1A and 1B and 3A to 3C, Dx may have a different value from that of Dy.

According to the scanning methods in FIGS. 1A and 1B and 3A to 3C, fringe scanning in the x-axis direction and y-axis direction may be implemented by Dx×Dy−1 movements. Though the moving distance may vary in accordance with the applied scanning method, mx and my may be defined as required such that the total moving distance may be shorter than a total moving distance according to a raster scan method. 26 movements are required according to a scanning method applying raster scan in the past, as illustrated in FIGS. 7A and 7B where Dx=Dy=4. However, a detection performed every movement in the first or second direction as illustrated in FIGS. 1A and 1B and 3A to 3C may allow reduction of the number of movements up to 15. This may reduce the imaging time. In a case where a subject is movable (such as a living body), a short imaging time may reduce a blur caused by motion of the subject. Therefore, this embodiment is more advantageous in a case where a subject is movable. In addition, in a case where a subject while moving is being irradiated with an X-ray, the exposed dose of the subject may be reduced.

According to this embodiment, Talbot-Lau interferometry is applied. However, this embodiment is also applicable to Talbot interferometry utilizing an X-ray source having a minute focal point without a source grating. Having described that a method which scans a phase grating according to this embodiment, those which are possibly scanned by a fringe scanning method such as an X-ray source (source grating) and a shield grating may be applicable scanning targets. In a case where the shield grating is scanned instead of scanning of a phase grating, Nx may be set as a period of the shield grating in the first direction and Ny may be set as a period of the shield grating in the second direction so that this embodiment is applicable thereto.

### Second Embodiment

According to this embodiment, a scanning method will be described which is suitable in a case where an actuator which causes backlash is used. This embodiment is the same as the first embodiment except for the method for moving a phase grating by a moving unit, and the repetitive description will be omitted.

In a case where an actuator to be used includes a relatively inexpensive stepping motor and gear, an operation for correcting mechanically occurring backlash may be performed. Therefore, the number of movements and moving distance increase more than a case where the operation for correcting backlash is not performed.

A method for moving a phase grating according to a raster scan method including a backlash correction operation will be described with reference to FIG. 7B. The arrows enclosed within dashed boxes in FIG. 7B indicate movements of a phase grating necessary for a backlash correction. The moving distance necessary for the backlash correction in the description of this embodiment is assumed to be equal to a distance of one movement of the grating once. In consideration of the backlash correction, the number of movements to be performed after the first detection is equal to 30, and the number of movements is increased by (Dy−1)×4 more than the scanning method illustrated in FIG. 7A. The moving distance also increases by (Dy−1)×4×Nx/Dx.

Accordingly, in this embodiment, the phase grating is moved only in a first direction to perform fringe scanning in the x-axis direction, and the phase grating is moved only in a second direction to perform fringe scanning in the y-axis direction. The other gratings or grids may be moved in the same manner. In other words, movements in the opposite direction are not performed to theoretically eliminate backlash occurring upon direction shift. This may eliminate the necessity for movement for backlash correction during an imaging operation, which thus reduce the number of movements and the moving distance. Therefore, the imaging time may be reduced. In a case where a subject is movable (such as a living body), a short imaging time may reduce a shake caused by motion of the subject. Therefore, this embodiment is more advantageous in a case where a subject is movable.

In addition, in a case where a subject while moving is being irradiated with an X-ray, the exposed dose of the subject may be reduced.

FIGS. 1A and 1B illustrate examples of phase grating scanning methods for performing fringe scanning without movements in the opposite direction. The scanning methods illustrated in FIGS. 1A and 1B may require a wider o range of motion than those of the scanning methods illustrated in FIGS. 3A to 3C. Therefore, an actuator such as a stepping motor and a linear motor may be used which is not easily restricted by its range of motion. However, though its range of motion is wide, the periods of the phase grating and shield grating may be as small as several μm to several tens μm. Therefore, the actuator is not easily restricted by its range of motion. Because backlash does not occur in a case where the actuator is a linear motor or a piezoelectric element which is relatively strictly restricted by its range of motion, the scanning methods as illustrated in FIGS. 1A and 1B are not required to be performed.

In order to reduce the moving distance, as illustrated in FIG. 1A, the moving distance of one movement in the first direction (illustrated right direction) may be equal to Nx/Dx, and the moving distance of one movement in the second direction (the illustrated downward direction) may be equal to Ny/Dy. However, mx and my may take any numerical values except for zero in the expression representing the moving distance. FIG. 1B illustrates an example in which the moving distance between the fourth detection and the fifth detection is equal to Ny+Ny/Dy (or my=1). However, mx and my may be defined such that the total moving distance is lower than Nx×(Dx−1)×(2Dy−1)÷Dx+Ny×(Dy−1)÷Dy+(Dy−1)×4×Nx/Dx.

The arrows enclosed within dashed boxes in FIGS. 1A and 1B indicate backlash corrections performed before an imaging operation, which may prevent an influence on the imaging time. The number of movements is equal to 19(Dx×Dy+3) including the number of movements due to a backlash correction performed before an imaging operation and is lower than the number of movements in the fringe scanning method applying the raster scan illustrated in FIG. 7B.

### Third Embodiment

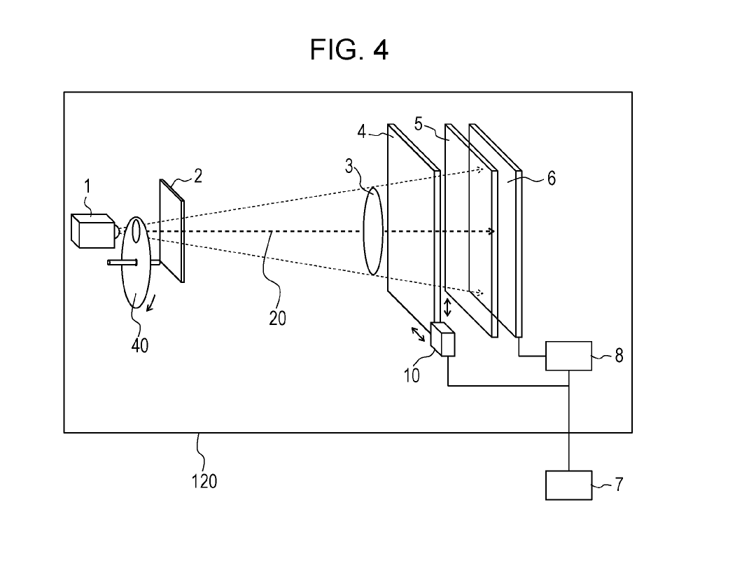

A Talbot interferometer 120 according to a third embodiment further includes an X-ray source 1 and a rotary shutter 40 in addition to the Talbot interferometer 110 of the first embodiment, as illustrated in FIG. 4. This embodiment is different from the first embodiment in that the rotary shutter operates in accordance with the scan of the phase grating. The rest of the configuration is the same as that of the first embodiment, and the repetitive description will be omitted.

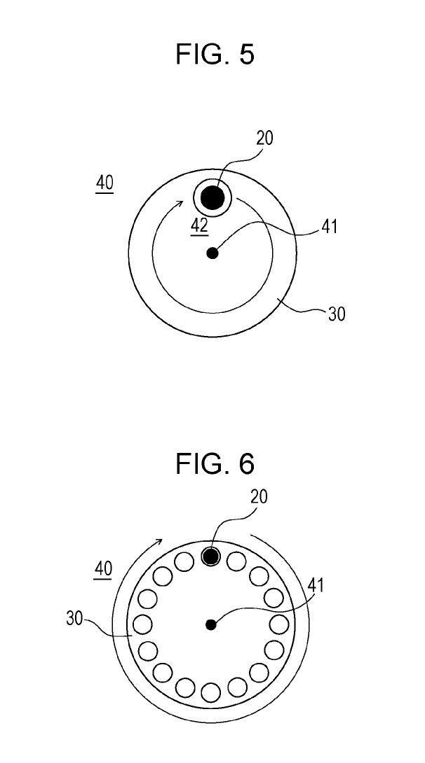

With reference to FIG. 1A and FIG. 4, synchronization between the rotary shutter 40 and a phase grating scanning method will be described. As illustrated in FIG. 5, the rotary shutter 40 has a shield unit 30 having an aperture 42 and a rotation axis 41. The shield unit may be rotated to the right or left about the rotation axis 41 to intermittently irradiate an X ray to a subject.

In this case, in synchronization with movements of an alignment point of the phase grating to the positions 1 to 16 as illustrated in FIG. 1A, the rotary shutter rotates such that the aperture 42 may be placed within an optical path. In other words, when the aperture 42 of the rotary shutter is placed first within an optical path, the alignment point of the phase grating is placed at the position 1 in FIG. 1A, and the detector performs the first detection. When the rotary shutter then rotates once and the aperture 42 is again placed within the optical path, the alignment point of the phase grating is placed at the position 2, and the detector performs the second detection. The same operations are repeated subsequently. When the aperture 42 is placed within the optical path, the aperture may be placed on the X-ray axis 20.

The use of a rotary shutter in this manner may prevent irradiation of an X-ray to a subject while the phase grating is moving. Therefore, the exposure dose to the subject may be reduced than the first embodiment though an imaging operation is performed in an equal period of time. The combination with the rotary shutter 40 is possible also in a case where the scanning methods illustrated in FIG. 1B and FIGS. 3A to 3C are performed.

Furthermore, the rotary shutter may be one including a shield unit having a plurality of apertures as illustrated in FIG. 6. The apertures may be placed for easy synchronization with the rotating speed of the shutter or the moving amount of the grating or grid. Therefore, the apertures 42 may not be placed at equal intervals but may be placed in accordance with the aspect ratio (Nx:Ny) of the periods of the phase grating or time points when detections are performed. For example, in a case where the scanning method illustrated in FIG. 1B is performed, an interval between an aperture to be placed within an optical path when the fourth detection is performed and an aperture to be placed within the optical path when the fifth detection is performed may be equal to five times of the intervals between other apertures. Thus, without changing the rotating speed, the timing of detections and timing of irradiations of an X-ray to a subject may be synchronized.

The use of the rotary shutter as in this embodiment may suppress vibrations occurring when the shutter is opened or closed and may advantageously inhibit drifts of the gratings. However, with an uninfluential level of vibrations, a sliding shutter may be used instead of a rotary shutter and may be opened and closed in the same timing to provide the same effects.

Having described that a phase grating is scanned also according to this embodiment, the source grating or shield grating, for example, may be scanned to change the relative positions of the first intensity distribution and the shield grating.

### Example

The Talbot interferometer according to the second embodiment will be described more specifically with reference to an example. The phase grating scanning method illustrated in FIG. 1A is applied in this example.

FIG. 2 illustrates a configuration of this example. An X-ray emitted from the X-ray source 1 passes through the source grating 2 and the subject 3, is diffracted by the phase grating 4 and forms a first intensity distribution on the shield grating 5. A part of the X-ray forming the first intensity distribution is shielded by the shield grating 5 so that the X-ray forms an intensity distribution. Information on the intensity distribution is detected from the X-ray from the shield grating by the detector 6. The detection is performed by the detector 6 in accordance with an instruction transmitted from the instruction unit 8 to the detector 6. The detection data from the detector 6 are transmitted to the arithmetic unit 7 connected with the Talbot interferometer, and information on a differential phase image of the subject 3 is calculated.

The phase grating 4 is configured to be capable of moving in two directions (first direction and second direction) along an arrangement of the phase grating by the moving unit 10 to adapt the fringe scanning method.

This example in this configuration will be described in more detail by giving specific numerical values.

It is assumed that the energy of an X-ray emitted from the X-ray source 1 is 35 keV (3.54×10⁻² nm).

The source grating 2 has an effective area of an square 12 mm on a side, and the phase grating 4 and the shield grating 5 have an effective area of squares 150 mm on a side. The effective area detectable by the detector 6 (or the detection range) is also a square having sides of 150 mm.

The phase grating 4 has phase shift units and phase reference units arranged in a checker pattern having periods of 10 μm each. The phase grating 4 contains silicon having a high x-ray transmittance and has projections arranged periodically on a grating surface to form the phase shift units and the phase reference units. In a case where the phase grating 4 is a m grating and 35 keV X-ray is irradiated, the height required for a phase shift is 33 μm in consideration of a refractive index difference (5.37×10⁻⁷) against the air. The phase grating is generated such that the height (projection) of the phase shift units may be higher by 33 μm than the phase reference units. As a moving unit for moving the phase grating, an XY stage utilizing the stepping motor is connected to a grating holder configured to hold the phase grating.

The source grating 2 and shield grating 5 have a grid pattern (or a mesh pattern), and the shield unit is plated with Au having a high X-ray absorptance. An X-ray passes through the other regions.

The periods of the source grating 2 and the shield grating 5 are equal to 12.8 μm and 8.24 μm, respectively, and Au is plated to a thickness 120 μm. The projection and planes are formed to have widths satisfying 1:1.

These gratings are placed as follows. The source grating 2 and phase grating 4 are placed such that the distance between the X-ray source 1 and the source grating 2 may be equal to 100 mm and the distance between the X-ray source 1 and the phase grating 4 may be equal to 1000 mm. In the Talbot interferometer of this example, because the Talbot distance is equal to 582 mm, the shield grating 5 is placed such that the distance between the X-ray source 1 and the shield grating 5 may be equal to 1582 mm.

After the gratings are placed, a fringe scanning method is used to perform an imaging operation. The phase grating is moved three times in the first direction and three times in the second direction (that is, Dx=Dy=4). In this case, because the periods (Nx, Ny) of the phase grating in the first direction and the second direction are both equal to 10 μm, one moving distance of the phase grating may be calculated as 2.5 μm from the following expression:

Nx/Dx=2.5

Therefore, in a case where the phase grating is scanned by a fringe scanning method applying raster scan which is a conventional method, the distance for moving the phase grating for one imaging operation is equal to 2.5×36=90 μm as illustrated in FIG. 7B. However, the moving distance necessary for backlash correction is assumed to be equal to the distance for moving the phase grating once (2.5 μm in this example), and backlash correction to be performed before an imaging operation is not considered. On the other hand, according to the phase grating scanning method of this example, the distance for moving the phase grating for one imaging operation may be equal to 2.5×15=37.5 μm as illustrated in FIG. 1A.

The time required for moving the grating once includes a duration for the movement according to the moving distance and a time for communication with an instruction unit which instructs the movement and a time for starting the movement. However, because the Talbot interferometer of this example may require a lower number of movements and a shorter moving distance than those of a Talbot interferometer with the conventional method, fringe scanning can be performed in the x-axis direction and y-axis direction in a shorter imaging time than the Talbot interferometer in the past.

Having described embodiments of the present invention above, the present invention is not limited to those embodiments, and various deformations and changes may be made thereto without departing from the spirit and scope of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-156730, filed Jul. 31, 2014, which is hereby incorporated by reference herein in its entirety.

What is claimed is:

1. A Talbot interferometer comprising:
a diffractive grating configured to diffract an X-ray from an X-ray source to form a first intensity distribution in which a bright section and a dark section are aligned in two directions;
a shield grating configured to shield a part of the X-ray forming the first intensity distribution to form a second intensity distribution in which a bright section and a dark section are aligned in an x-axis direction and a y-axis direction;
a detector configured to detect an intensity of an X-ray from the shield grating to acquire information on the intensity distributions; and
a moving unit configured to move the first intensity distribution or the shield grating,
wherein fringe scanning in the x-axis direction is performed in response to
a change in relative positions of the first intensity distribution and the shield grating in the x-axis direction by the moving unit, and
the detection before or after a change in the relative positions in the x-axis direction by the detector;
fringe scanning is performed in the y-axis direction in response to
a change in relative positions of the first intensity distribution and the shield grating in the y-axis direction by the moving unit; and
the detection before or after a change in the relative positions in the y-axis direction by the detector; and
the number of movements of the first intensity distribution or the shield grating by the moving unit involved in the fringe scanning in the x-axis direction and fringe scanning in the y-axis direction is lower than Dx×(Dy+1)−2,
where Dx is the number of detections involved in the fringe scanning in the x-axis direction,
Dy is the number of detections involved in the fringe scanning in the y-axis direction, and Dx and Dy are both integers equal to or higher than 3.

2. The Talbot interferometer according to claim 1, wherein a sum of moving distances of the first intensity distribution by the moving unit involved in the fringe scanning in the x-axis direction and the fringe scanning in the y-axis direction is shorter than Nx×(Dx−1)×(2Dy−1)÷Dx+Ny×(Dy−1)÷Dy,
in a case where the moving unit moves the first intensity distribution to move the relative positions in the x-axis direction and the relative positions in the y-axis direction,
Nx is a period of the first intensity distribution in the first direction; and
Ny is a period of the first intensity distribution in the second direction; and
in a case where the moving unit moves the shield grating to move the relative positions in the x-axis direction and the relative positions in the y-axis direction, Nx is a period of the shield grating in the first direction; and
Ny is a period of the shield grating in the second direction.

3. A Talbot interferometer comprising:
a diffractive grating configured to diffract an X-ray from an X-ray source to form a first intensity distribution in which a bright section and a dark section are aligned in two directions;
a shield grating configured to shield a part of the X-ray forming the first intensity distribution to form an intensity distribution in which a bright section and a dark section are aligned in an x-axis direction and a y-axis direction;
a detector configured to detect an intensity of an X-ray from the shield grating to acquire information on the intensity distributions; and
a moving unit configured to move at least one of the first intensity distribution and the shield grating,
wherein fringe scanning in the x-axis direction is performed in response to
a change in relative positions of the first intensity distribution and the shield grating in the x-axis direction by the moving unit, and
the detection before or after a change in the relative positions in the x-axis direction by the detector;
fringe scanning is performed in the y-axis direction in response to
a change in relative positions of the first intensity distribution and the shield grating in the y-axis direction by the moving unit; and
the detection before or after a change in the relative positions in the y-axis direction by the detector; and
a sum of the moving distance of the first intensity distribution by the moving unit involved in the fringe scanning in the x-axis direction and fringe scanning in the y-axis direction is shorter than Nx×(Dx−1)×(2Dy−1)÷Dx+Ny×(Dy−1)÷Dy,
in a case where the moving unit moves the first intensity distribution in a first direction to move the relative positions in the x-axis direction and moves the first intensity distribution in a second direction to move the relative positions in the y-axis direction,
Nx is a period of the first intensity distribution in the first direction; and
Ny is a period of the first intensity distribution in the second direction; and
in a case where the moving unit moves the shield grating in a first direction to move the relative positions in the x-axis direction and moves the shield grating in a second direction to move the relative positions in the y-axis direction, Nx is a period of the shield grating in the first direction; and
Ny is a period of the shield grating in the second direction.

4. The Talbot interferometer according to claim 1, wherein
the moving unit
moves the first intensity distribution or the shield grating in a first direction only to change the relative positions of the first intensity distribution and the shield grating in the x-axis direction; and
moves the first intensity distribution or the shield grating in a second direction intersecting the first direction to change the relative positions of the first intensity distribution and the shield grating in the y-axis direction.

5. The Talbot interferometer according to claim 2, wherein
the moving unit
moves the first intensity distribution or the shield grating in a first direction only to change the relative positions of the first intensity distribution and the shield grating in the x-axis direction; and
moves the first intensity distribution or the shield grating in a second direction intersecting the first direction to change the relative positions of the first intensity distribution and the shield grating in the y-axis direction.

6. The Talbot interferometer according to claim 3, wherein
the moving unit
moves the first intensity distribution or the shield grating in a first direction only to change the relative positions of the first intensity distribution and the shield grating in the x-axis direction; and
moves the first intensity distribution or the shield grating in a second direction intersecting the first direction to change the relative positions of the first intensity distribution and the shield grating in the y-axis direction.

7. The Talbot interferometer according to claim 1, wherein,
between two successive detections performed by the detector,
the moving unit
moves the relative positions in the first direction or moves the relative positions in the second direction.

8. The Talbot interferometer according to claim 2, wherein,
between two successive detections performed by the detector,
the moving unit
moves the relative positions in the first direction and moves the relative positions in the second direction.

9. The Talbot interferometer according to claim 3, wherein,
between two successive detections performed by the detector,
the moving unit
moves the relative positions in the first direction or moves the relative positions in the second direction.

10. The Talbot interferometer according to claim 7, wherein,
between two successive detections performed by the detector,
the moving unit
changes the relative positions in the first direction by Nx×mx+Nx/Dx or
changes the relative positions in the second direction by Nx x my+Nx/Dx,
in a case where the moving unit moves the first intensity distribution in a first direction to move the relative positions in the x-axis direction and moves the first intensity distribution in a second direction to move the relative positions in the y-axis direction,
Nx is a period of the first intensity distribution in the first direction; and
Ny is a period of the first intensity distribution in the second direction; and
in a case where the moving unit moves the shield grating in a first direction to move the relative positions in the x-axis direction and moves the shield grating in a second direction to move the relative positions in the y-axis direction,
Nx is a period of the shield grating in the first direction;
Ny is a period of the shield grating in the second direction; and
mx and my are integers equal to or higher than zero.

11. The Talbot interferometer according to claim 1, wherein
the number of movements is equal to Dx×Dy−1.

12. The Talbot interferometer according to claim 2, wherein
the number of movements is equal to Dx×Dy−1.

13. The Talbot interferometer according to claim 3, wherein
the number of movements is equal to Dx×Dy−1.

14. The Talbot interferometer according to claim 1, wherein the moving unit moves the first intensity distribution in the first direction, in the opposite direction of the first direction, in the second direction and in the opposite direction of the second direction before fringe scanning performed in the x-axis direction and fringe scanning performed in the y-axis direction.

15. The Talbot interferometer according to claim 1, wherein the moving unit moves the shield grating in the first direction, in the opposite direction of the first direction, in the second direction and in the opposite direction of the second direction before fringe scanning performed in the x-axis direction and fringe scanning performed in the y-axis direction.

16. The Talbot interferometer according to claim 1, wherein
the X-ray source is
a virtual X-ray source generated by a source grating having a shield unit and a plurality of transmission units and dividing an irradiated X-ray.

17. The Talbot interferometer according to claim 1, further comprising a shutter capable of shielding and transmission of an X-ray from the X-ray source, wherein the shutter has a shield unit having transmission parts and is placed between the X-ray source and a subject;
the shield unit rotates about a rotation axis so that irradiation of an X-ray to the subject may be performed intermittently.

18. A Talbot interference system comprising:
the Talbot interferometer according to claim 1; and
an arithmetic unit configured to calculate information on a subject by using a detection result from the detector,
wherein the arithmetic unit
calculates information on a subject in the x-axis direction by using a detection result acquired by performing fringe scanning in the x-axis direction; and
calculates information on the subject in the y-axis direction by using a detection result acquired by performing fringe scanning in the y-axis direction.

19. The Talbot interference system according to claim 18, wherein
information on a subject in the x-axis direction is phase information of an X-ray in the x-axis direction or scatter information of an X-ray in the x-axis direction; and
information on a subject in the y-axis direction is phase information of an X-ray in the y-axis direction or scatter information of an X-ray in the y-axis direction.

20. A fringe scanning method usable in a Talbot interferometer including a diffractive grating configured to diffract an X-ray from an X-ray source to form a first intensity distribution in which a bright section and a dark section are aligned in two directions, a shield grating configured to shield a part of the X-ray forming the first intensity distribution to form an intensity distribution in which a bright section and a dark section are aligned in an x-axis direction and a y-axis direction, and a detector configured to detect an intensity of an X-ray from the shield grating to acquire information on the intensity distributions,
wherein the number of movements of the first intensity distribution and the shield grating involved in the fringe scanning in the x-axis direction and the fringe scanning in the y-axis direction is lower than Dx×(Dy+1)−2,
where Dx is the number of detections involved in the fringe scanning in the x-axis direction;
Dy is the number of detections involved in the fringe scanning in the y-axis direction; and
Dx and Dy are both integers equal to or higher than 3.
